(19) United States
(12) Patent Application Publication
(10) Pub. No.: US 2025/0051864 A1
(43) Pub. Date: Feb. 13, 2025

(54) ZEOLITE PARTICLES

(71) Applicants: PQ Silicas UK Limited, Cheshire (GB); PQ Silicas BV, Eijsden (NL)

(72) Inventors: Simon Stebbing, Warrington (GB); Roger Janssen, Riemst (BE); Moses Rathbun, Maastricht (NL)

(21) Appl. No.: 18/720,916

(22) PCT Filed: Dec. 21, 2022
(86) PCT No.: PCT/GB2022/053344

§ 371 Date: Jun. 17, 2024

(30) Foreign Application Priority Data
Dec. 22, 2021 (GB) 2118809.9

(51) Int. Cl. C14C 3/26; C01B 39/14

(52) U.S. Cl. CPC C14C 3/26; C01B 39/14

(57) ABSTRACT

Described is a method of manufacturing zeolite particles comprising a C1-C4 carboxylate suitable for use in leather tanning, the method comprising the steps of (i) contacting a zeolite particle slurry with a C1-C4 carboxylic acid to increase the acidity of the zeolite particles; and (ii) removing liquid from the slurry to obtain the zeolite particles comprising the C1-C4 carboxylate. Zeolite particles suitable for use in leather tanning, and methods of manufacturing a tanning composition using zeolite particles comprising a C1-C4 carboxylate, are also described.

### FIELD OF INVENTION

The present invention relates to zeolite particles suitable for use in leather tanning, methods of manufacturing zeolite particles suitable for use in leather tanning and to use of the zeolite particles in leather tanning.

### BACKGROUND

Tanning plays an important role in the process for making leather goods and is known to impart both strength and water resistance to the hide being tanned. Various chemicals are typically used within the tanning process, with chromium (in the form of Cr³⁺) being the most common. The use of chromium, however, is under increasing pressure due to its detrimental environmental impact. Various alternatives have been proposed but many of these give poorer quality products.

It is also known to use zeolite 4A treated with formic acid, as described in EP2574682. It has been proposed that using zeolite 4A treated with formic acid in the tanning process can result in products that are comparable in quality to chromium-tanned products. EP2574682 describes a process whereby the zeolite is sprayed with concentrated carboxylic acid to provide acidified zeolite particles.

Zeolite 4A is a powder with an average particle diameter of around 3 microns. For it to be usable in tanning, it needs to be brought into a dispersed and partially dissolved state such that the material is fine enough to be able to penetrate into the hides being tanned and react with the collagen inside. Zeolite 4A itself is not soluble in water but can be brought into a partially dissolved state if the pH is low enough. Zeolite 4A as manufactured is alkaline with a pH of around 11 when provided in an amount of 1% wt. in an aqueous suspension. By spraying a carboxylic acid, typically formic acid, to a zeolite powder bed that is being moved inside a mixer, the alkalinity can be reduced and zeolite particles that comprise a carboxylate are generated (i.e. by protonation of at least some basic sites on the zeolite). This process is herein referred to as a spray-on process.

The spray-on process suffers from several disadvantages. Firstly, formic acid is a volatile liquid and the vapour present inside the mixer risks forming a combustible atmosphere. To reduce explosion risk, the amount of vapour in the spray-on process must be controlled and typically the temperature must be maintained below 50° C. Because the zeolite acidification is an exothermic process, heat is produced and so to maintain a temperature below 50° C., the reaction mixture needs to be actively cooled. The cooling rate is usually quite low and therefore leads to a low rate of manufacture of the product. As a result, the process incurs safety risks and a high degree of procedural care to manage, whilst also suffering from lower rates of manufacture.

Moreover, the addition of formic acid leads to an inevitable increase in zeolite particle diameter relative to the zeolite 4A starting powder. Zeolite 4A starting powder has a typical weight average particle diameter of around 3 microns. Acid treated zeolite material obtained by the described acid spray process is usually an order of magnitude larger than this. Since the zeolite compound needs to be brought into a dispersed and partially dissolved state when it is used within the tanning process, significant increases in particle diameter are undesirable as this can diminish the ability of the particles to penetrate into the hide. Present methods attempt to address this by drying the zeolite to an excessive extent (“over drying”) prior to conducting the spray-on process. Such “overdried” zeolite typically has a solids content of at least 86%, compared to 80% for typically manufactured zeolite 4A. The use of an overdried zeolite has been observed to limit the increase in particle diameter normally observed during the spray-on process, but this extensive drying is an energy intensive step that is commercially unattractive. The overdried material must also be carefully handled so it stays dry prior to the formic acid spray treatment, which adds procedural complexity.

It is an object of the present invention to obviate or mitigate one or more of the above-mentioned disadvantages.

### SUMMARY OF THE INVENTION

In general, the present invention proposes a new methodology for synthesizing zeolite particles comprising a carboxylate, i.e. carboxylic acid treated zeolite particles, suitable for use in tanning compositions. Specifically, it has been found to be possible to produce zeolite particles comprising a C1-C4 carboxylate using a slurry process instead of the known spray-on process. That is, the applicant has developed a process whereby the zeolite particles are treated with a C1-C4 carboxylic acid (for the purpose of use in tanning compositions) in a slurry process. This has been found to offer advantages over the spray process described above. Herein, we refer to the general process of the invention as a slurry route or slurry process for convenience. As a result of this methodology, zeolite particles comprising a carboxylate (i.e. acidified zeolite particles) with improved particle properties compared to prior art methods have been obtained. It will be appreciated that following acid treatment to form the zeolite particles comprising carboxylate, some free acid may be present. For the avoidance of doubt, it will be appreciated that the zeolite particles comprising a carboxylate may thus in embodiments contain some of the corresponding carboxylic acid.

Advantageously, the zeolite particles comprising a carboxylate obtained by the slurry route are particularly suitable for use in leather tanning applications, and in particular as a leather tanning agent. The zeolite particles comprising a carboxylate obtained by the slurry route comprise a significantly higher fraction of smaller zeolite particles compared to other known methods. Without wishing to be bound by theory, this higher proportion of smaller particles means that the zeolite particles can be more easily brought into a colloidal state and penetrate into the hides being tanned.

The zeolite particles comprising a carboxylate (i.e. the acidified zeolite particles) obtained by the slurry route typically have lower crystallinities compared to other known methods. Without wishing to be bound by theory, this lower crystallinity is believed to be a consequence of a more even and homogeneous distribution of the acid over the surface of the zeolite particles.

Advantageously, the slurry process described herein avoids the practical and safety problems attributed to spraying of concentrated acid, e.g. formic acid, described above. It is also able to deliver zeolite particles comprising a carboxylate having a comparatively smaller particle diameter than spray methods, whilst also avoiding the need for “overdrying” of the zeolite material prior to acid treatment. Since overdrying of the starting zeolite prior to the acidification reaction is known to reduce the product particle diameter in the prior spray processes (and conversely, increasing the water content (re-wetting) is observed to significantly increase the particle size—see comparative examples), it is surprising, and indeed counter-intuitive, that the presently described slurry-based process would provide the observed beneficial outcome in terms of particle size.

Moreover, zeolites particles are generally manufactured by crystallisation processes, which result in a zeolite slurry initially, i.e. zeolite crystals dispersed in a liquid, usually water. The methods of the invention have the advantage that this slurry may be directly used as the initial slurry feedstock that is to be subject to treatment with the carboxylic acid. This means that zeolite particles comprising a C1-C4 carboxylate (i.e. acidified zeolite particles) for tanning can advantageously be produced according to the invention by zeolite manufacturers simply by adding an acid treatment step to the usual zeolite crystallisation process. This compares favourably to spray-on methods of the prior art, which require the initial isolation and drying of the starting zeolite following the regular manufacturing process, before then treating the zeolite by spraying with formic acid in a distinct and specialised spraying apparatus.

In the first aspect of the invention there is provided a method of manufacturing zeolite particles comprising a C1-C4 carboxylate suitable for use in leather tanning, the method comprising the steps of:
(i) contacting a zeolite particle slurry with the C1-C4 carboxylic acid to increase the acidity of the zeolite particles; and
(ii) removing liquid from the slurry to obtain the zeolite particles comprising the C1-C4 carboxylate.

The term “slurry” is well known in the art but for the avoidance of doubt is used herein to indicate a mixture where solid particles are dispersed within a liquid (in the case of the method described herein, the solid particles are zeolite particles).

It will be appreciated that in increasing the acidity of the zeolite particles within step (i) of the first aspect of the invention, at least some of the C1-C4 carboxylic acid is converted to a C1-C4 carboxylate (i.e. the conjugate base) and becomes associated with the zeolite particles.

The “increase the acidity of the zeolite particles” may be measured by assessing the pH of the zeolite particles when dispersed within water. Increasing the acidity of the particles does not necessarily mean to make acidic (i.e. produce a pH less than 7) although in an optional embodiment the process does entail producing zeolite particles comprising a C1-C4 carboxylate having an acidity such that the pH of the zeolite particles is less than 7. When pH is mentioned herein with reference to the acidity of solid particles, the pH may be determined by dispersing 1 g of the solid particles on a dry mass basis in 99 g of deionised water at 20° C. and atmospheric pressure and measuring the resulting pH of the water. This may in embodiments provide a pH below 8. Accordingly, in embodiments, zeolite particles comprising a C1-C4 carboxylate according to the invention, have an acidity such that 1 g of the zeolite particles on a dry mass basis dispersed in 99 g of deionised water at 20° C. and atmospheric pressure has a pH below 8. The pH may in embodiments be 7.8 or below, 7.6 or below, 7.5 or below, 7.4 or below, or 7.2 or below. The pH may be 7 or below, e.g. less than 7. Such particles have been found to exhibit especially good tanning leather properties. Preferably, the pH is from 5 to 8, even more preferably from 6 to 7.5, or from 6 to 7. Particles having a pH of from 5 to 8, especially below 8, such as 6 to 7.5, or from 6 to 7, or less than 7 have been found to exhibit especially good tanning leather properties.

The slurry process of the first aspect of the invention presents an improvement in the properties of the zeolite particles produced, the safety requirements for the process and the efficiency of production compared to prior art methods.

As described in more detail in the examples below, the slurry process provides an effective method for increasing the acidity of zeolite particles using the C1-C4 carboxylic acid, and produces a significantly higher fraction of smaller zeolite particles compared to other known methods. The method also provides zeolite particles comprising a C1-C4 carboxylate with a reduced crystallinity compared to other known methods. These particles are particularly beneficial for leather tanning, as described above. The production of these improved particles can be considered counter-intuitive. The standard method for ensuring a reduced particle diameter in conventional spray methods is to use overdried zeolite particles, i.e. zeolite particles with a reduced water content. It is therefore surprising that the presently claimed slurry process, which has a very high liquid content, would have the effect of producing particles having a comparatively smaller diameter.

Further, the slurry process may provide benefits to the operational safety and operational efficiency of producing zeolite particles comprising a C1-C4 carboxylate. Applying the formic acid directly to a slurry, means the presence of a combustible carboxylic acid vapour atmosphere is highly reduced compared to the spray-on route. The slurry process may also reduce the requirement for external cooling of the reaction, wherein the need for cooling can otherwise limit the rate at which the zeolite particles are produced.

In a second aspect of the invention there is provided zeolite particles comprising a C1-C4 carboxylate obtainable or obtained by the method according to the first aspect of the invention.

In a third aspect of the invention there is provided zeolite particles suitable for use in leather tanning, wherein the zeolite particles have an acidity such that 1 g of the zeolite particles on a dry mass basis dispersed in 99 g of deionised water at 20° C. and atmospheric pressure exhibits a pH of from 5 to 8, wherein the zeolite particles comprise a C1-C4 carboxylate, and wherein at least 90% by weight of the zeolite particles have a particle diameter of 50 μm or less.

In the third aspect of the invention at least 90% by weight of the zeolite particles have a particle diameter of 50 μm or less. Put another way, less than 10% by weight of the zeolite particles have a particle diameter greater than 50 μm. As described above, a high proportion of small particles may allow the zeolite particles to be more easily brought into a dispersed and partially dissolved state and penetrate into the hides being tanned. In particularly advantageous embodiments of the present invention at least 92% by weight, e.g. at least 95% by weight or at least 96% by weight, of the zeolite particles comprising a C1-C4 carboxylate have a particle diameter of 50 μm or less.

As used herein, references to the fraction of zeolite particles having a given particle diameter, such as a particle diameter of 50 μm or less, are intended to refer to measurements determined by air sieve. In the case of a particle diameter of 50 μm or less, this may thus be measured by determining the weight percentage of particles able to pass through an air sieve (e.g. a Hosokawa Alpine 200LS) with a 50 micron mesh. The data presented throughout the specification has been calculated in this manner and further details are provided in the methods section below. It will be appreciated that for non-spherical particles, the term “particle diameter” as used herein refers to the length of the critical width dimension that determines the ability of the particles to pass through the mesh of the air sieve. This may be thought of as the diameter of a sphere that would pass through a mesh having apertures of the given size. Zeolite particles with this advantageous particle diameter parameter may be conveniently provided by the processes of the invention as described herein. The particles according to the invention are thus highly desirable for animal hide tanning (e.g. leather tanning) whereby the relatively small particle diameter is beneficial for penetrating the animal hide when used in tanning compositions.

In typical embodiments of the third aspect, the zeolite particles are provided in the form of a powder.

In a fourth aspect of the invention there is provided a tanning composition comprising the zeolite particles comprising a C1-C4 carboxylate of the second or third aspects of the invention in combination with one or more excipients. The zeolite particles may be dry-mixed with other tanning ingredients. The resulting powder can then brought into a dispersed and partially dissolved state to be used to penetrate a hide. This tanning solution may have a pH of from 2 to 7, for example of from 3 to 6, such as of from 4 to 6.

In a fifth aspect of the invention there is provided a method of manufacturing a tanning composition comprising: (i) manufacturing zeolite particles comprising a C1-C4 carboxylate by the method according to the first aspect of the invention, and (ii) combining the zeolite particles comprising the C1-C4 carboxylate with one or more excipients to provide a tanning composition. The method of the fifth aspect of the invention may comprise dry-mixing the zeolite particles comprising the C1-C4 carboxylate with other tanning ingredients.

In a sixth aspect of the invention there is provided a method of manufacturing a tanning composition comprising: combining the zeolite particles comprising the C1-C4 carboxylate according to the third aspect of the invention with one or more excipients to provide a tanning composition. The method of the sixth aspect of the invention may comprise dry-mixing the zeolite particles comprising the C1-C4 carboxylate with other tanning ingredients.

In the fifth and sixth aspects of the invention, the zeolite particles comprising a C1-C4 carboxylate may be subject to particle size modification, e.g. milling, comminution and/or sieving prior to combining with one or more excipients. In optional embodiments, no comminution or milling is performed prior to combining with one or more excipients. In embodiments, no such particle size modification steps are performed prior to combining with one or more excipients.

In a seventh aspect of the invention there is provided use of the zeolite particles comprising the C1-C4 carboxylate of the second or third aspect of the invention, or the composition of the fourth aspect of the invention, in a method of tanning an animal hide. The method will comprise contacting the animal hide with the zeolite particles comprising the C1-C4 carboxylate of the second or third aspect of the invention, or the composition of the fourth aspect of the invention.

For example, the disclosure provides a method of tanning an animal hide (e.g. leather), the method comprising contacting the tanning composition according to the fourth aspect of the invention with the animal hide.

### DETAILED DESCRIPTION

Embodiments of the various aspects of the invention are described below. For the avoidance of doubt, it will be appreciated, where appropriate, that any embodiments as described herein in relation to one aspect of the present invention will also apply to the other aspects of the present invention.

### First Aspect

In embodiments of the first aspect of the invention, the wt % of zeolite particles in the slurry on a dry mass basis is from 10 wt % to 55 wt % relative to the total weight of the slurry. The wt % of zeolite particles in the slurry has been observed by the inventors to have an effect on the diameter of the zeolite particles comprising the C1-C4 carboxylate obtained from the method of the first aspect of the invention. Specifically, the examples show that the fraction of zeolite particles comprising a C1-C4 carboxylate that have a particle diameter of 50 μm or less can be altered by changing the wt % of starting zeolite particles in the slurry (see FIG. 1 and table 2).

In some embodiments, the wt % of zeolite particles in the slurry on a dry mass basis is from 15 wt % to 50 wt % relative to the total weight of the slurry, e.g. from 20-40 wt %, such as from 25 wt % to 40 wt % relative to the total weight of the slurry.

In some embodiments, the wt % of zeolite particles in the slurry on a dry mass basis is from 20 wt % to 30 wt % relative to the total weight of the slurry, e.g. the wt % of zeolite particles in the slurry may be 25 wt % relative to the total weight of the slurry.

It has been found that zeolite particles comprising the C1-C4 carboxylate produced from slurries with a relatively lower zeolite content can show a greater number of smaller particles compared to particles produced from slurries with a higher zeolite content. For example, FIG. 1 and table 2 show that using a 25 wt % slurry provides a smaller fraction of zeolite particles comprising a C1-C4 carboxylate which have a particle diameter of 50 μm or less compared to a zeolite particle comprising a C1-C4 carboxylate obtained from using a 40 wt % slurry.

However, it will be appreciated that using a lower zeolite content slurry may affect the throughput of the process and therefore a balance of these factors may need to be considered by the skilled person.

In embodiments of the first aspect of the invention, the step of removing liquid from the slurry is performed such that the zeolite particles comprising the C1-C4 carboxylate obtained have a solids content of at least 70%. The solids content may be of from 70% to 85%, optionally of from 70% to 80%. The solids content of the final powder can affect handling qualities and may be chosen so as to allow it to be dry mixed with other tanning agents. The present invention allows zeolite particles with both favourable properties and a suitable solids content to be produced. Further, the present invention may avoid over drying the zeolite particles at any stage, which can be energy intensive.

The C1-C4 carboxylic acid used in step (i) of the above process may be any acid with a carboxyl group and containing from 1 to 4 carbon atoms. For avoidance of doubt, the carbon atom of the carboxyl group is included in the 1 to 4 carbon atoms. The carboxylic acid may have a pKa of from 2 to 6, for example a pKa of from 3 to 5. The C1-C4 carboxylic acid may be a monocarboxylic acid. The C1-C4 carboxylic acid may be a C1-C2 carboxylic acid. It may be selected from the group consisting of formic acid, acetic acid, propionic acid, glycolic acid and lactic acid, or may be a mixture of two or more thereof. In preferred embodiments, the C1-C4 carboxylic acid is formic acid or acetic acid, for example, formic acid. Zeolite particles comprising a short chain carboxylate, and in particular formate, have been shown to be particularly beneficial for use in preparing useful zeolite tanning agents.

The zeolite particles in the slurry prior to contacting the zeolite particle slurry with the C1-C4 carboxylic acid may be any suitable zeolite, for instance, they may comprise type A, type P or type X zeolite. In preferred embodiments, the zeolite particles in the slurry comprise zeolite 4A. The zeolite particles in the slurry may consist solely of zeolite 4A. In particularly preferred embodiments, the zeolite particles in the slurry prior to contacting the zeolite particle slurry with the C1-C4 carboxylic acid are substantially entirely crystalline, preferably entirely crystalline (i.e. 100% zeolite 4A). Zeolite particles comprising a C1-C4 carboxylate produced from a slurry of zeolite 4A particles have been shown to be particularly beneficial as a tanning agent.

In embodiments, the slurry is an aqueous slurry of zeolite particles and the step of removing liquid is removing water. Aqueous solutions provide ready processability and pose fewer safety issues. In such embodiments, removing water may comprise drying the slurry, such as by air drying.

Prior to the step of contacting the zeolite particle slurry with the C1-C4 carboxylic acid, the method may comprise the step of preparing the zeolite slurry. The preparation may comprise dispersing zeolite particles in a liquid.

For avoidance of doubt, there is thus provided a method of manufacturing zeolite particles comprising a C1-C4 carboxylate suitable for use in leather tanning, the method comprising the steps of:
(i) dispersing zeolite particles in a liquid to provide a zeolite particle slurry;
(ii) contacting the zeolite particle slurry with a C1-C4 carboxylic acid to increase the acidity of the zeolite particles; and
(iii) removing liquid from the slurry to obtain the zeolite particles comprising the C1-C4 carboxylate.

The zeolite particle slurry may be obtained as the product of a zeolite manufacturing process. For instance, the preparation may comprise crystallizing the zeolite particles from a liquid, optionally water, to produce the zeolite particle slurry. For avoidance of doubt, there is thus provided a method of manufacturing zeolite particles comprising a C1-C4 carboxylate suitable for use in leather tanning, the method comprising the steps of:
(i) crystallizing zeolite particles from a liquid, optionally water, to produce a zeolite particle slurry;
(ii) contacting the zeolite particle slurry with a C1-C4 carboxylic acid to increase the acidity of the zeolite particles; and
(iii) removing liquid from the slurry to obtain the zeolite particles comprising the C1-C4 carboxylate.

Crystallizing the zeolite from a liquid may comprise using sodium hydroxide.

As discussed above, zeolites particles are generally manufactured by crystallisation processes, which result in a zeolite slurry initially, i.e. zeolite particles dispersed in a liquid, usually water. This slurry may then be directly used as the slurry, which is contacted with the carboxylic acid. This means that zeolite particles comprising the C1-C4 carboxylate for tanning can advantageously be produced according to the invention by zeolite manufacturers simply by adding an additional acidification step to the usual zeolite crystallisation process. This offers considerable procedural advantages compared to the spray-on method, whereby the zeolite particles must first be obtained by robust process and drying steps, and then subjected to spraying with the acid.

In embodiments of the first aspect of the invention, the C1-C4 carboxylic acid is added in an amount from 5 wt % to 30 wt % relative to the solids content of the zeolite particles in the slurry on a dry mass basis. The C1-C4 carboxylic acid may for instance be added in an amount of from 10 wt % to 25 wt %, e.g. 15 wt % to 25 wt % or 15 wt % to 20 wt %. Controlling the quantity of carboxylic acid in the method allows for control of the amount of carboxylate incorporated into the zeolite particles and, as a result, the pH of the zeolite particles comprising the C1-C4 carboxylate.

In embodiments of the first aspect of the invention, the C1-C4 carboxylic acid has a purity (prior to contacting the slurry) of from 95% to 100%, such as from 98% to 100%. The C1-C4 carboxylic acid may have a purity greater than 99% (i.e. it may be neat acid). In other words, the carboxylic acid may be provided in a concentration (prior to contacting the slurry) of from 95% to 100%, such as from 98% to 100%.

In embodiments, the step of contacting a zeolite particle slurry with the C1-C4 carboxylic acid to increase the acidity of the zeolite particles occurs at a temperature of from 18° C. to 25° C., e.g. 19° C. to 23° C., preferably 20° C. The step of contacting a zeolite particle slurry with the C1-C4 carboxylic acid to increase the acidity of the zeolite particles may thus occur at around 20° C. Advantageously, using a relatively low temperature increases the operational practicality of the method and increases safety, and may lead to an increased rate of manufacture of the particles compared to known methods. As discussed previously, the known spray-on method requires active cooling to maintain the temperature below 50° C. in order to limit the presence of a formic acid vapour. The cooling rate is usually quite low and therefore leads to a low rate of manufacture of the product.

In embodiments of the first aspect of the invention, the zeolite particles comprising the C1-C4 carboxylate as produced by the process may be as defined for the zeolite particles according to any embodiment of the third aspect of the invention described herein. That is, the particles produced by the method of the invention may have the features described below for any embodiment of the third aspect of the invention.

As described above, the zeolite particles comprising the C1-C4 carboxylate produced according to the process of the first aspect of invention are suitable for use in tanning compositions. In embodiments, the method thus further includes the step of using the zeolite particles comprising the C1-C4 carboxylic acid in the production of a tanning composition, e.g. by including the particles in a tanning composition. Such tanning compositions may contain other excipients and/or agents useful in tanning as will be known to the skilled person.

The zeolite particles containing a C1-C4 carboxylate obtained following the method steps described may be subject to particle size modification, e.g. milling, comminution and/or sieving prior to inclusion in the tanning composition. In optional embodiments, no comminution or milling is performed prior to inclusion in the tanning composition. In embodiments, no such particle size modification steps are performed prior to including the zeolite particles in the tanning composition.

### Second Aspect

In embodiments of the second aspect of the invention, at least 90% by weight of the zeolite particles have a particle diameter of 50 μm or less. As discussed in relation to the third aspect of the invention, a high proportion of small particles is understood to allow the zeolite particles to be more easily brought into a dispersed and partially dissolved state and penetrate into the hides being tanned.

In embodiments of the second aspect of the invention, the C1-C4 carboxylate is formate. Zeolite particles comprising formate have been shown to be particularly beneficial as a tanning agent.

In embodiments of the second aspect of the invention, the crystallinity of the zeolite particles comprising the C1-C4 carboxylate expressed as a percentage relative to the crystallinity of the zeolite particles measured prior to being contacted with the C1-C4 carboxylic acid is 70% or less.

Without wishing to be bound by theory, this lower crystallinity is believed to be a consequence of a more even and homogeneous distribution of the acid over the surface of the zeolite particles.

In embodiments of the second aspect of the invention, the zeolite particles comprising the C1-C4 carboxylic acid have the features described below for any embodiment of the third aspect of the invention.

### Third Aspect

In embodiments of the third aspect of the invention, the zeolite particles comprising the C1-C4 carboxylate have a solids content of at least 70%. The solids content may be of from 70% to 85%, optionally of from 70% to 80%. As mentioned in relation to the first aspect, the solids content of the zeolite particles can affect the handling qualities of the material. Further, controlling the solids content may allow the particles to be readily dry mixed with other tanning agents/excipients. Zeolite particles with both favourable properties and a suitable solids content can be produced using the method according to the first aspect of the invention.

In embodiments of the third aspect of the invention, the zeolite particles comprising the C1-C4 carboxylate have a crystallinity of 70% or less when measured against substantially crystalline zeolite particles (e.g. 100% crystalline) of the same type of zeolite. The skilled person will appreciate that in this context it is intended to refer to highly crystalline zeolite particles suitable for use as a crystallographic standard, which may typically be 100% crystalline. In other words, the crystallinity of the zeolite particles comprising the C1-C4 carboxylate may be 70% or less relative to highly crystalline zeolite particles of the same type of zeolite which do not comprise a C1-C4 carboxylate. As an example, if the zeolite particles comprising the C1-C4 carboxylate are zeolite 4A particles comprising formate, the crystallinity would be measured against a highly crystalline zeolite 4A standard. The highly crystalline zeolite particles used as the standard (reference) may, for example, be the zeolite particles used in forming the zeolite particle slurry in the method according to the first aspect of the invention.

The crystallinity percentage may be calculated by comparing the peak area of the refraction peaks obtained via X-ray diffraction of the zeolite particles comprising the C1-C4 carboxylate against the peak area of the same amount of substantially crystalline zeolite particles (e.g. 100% crystalline) of the same type of zeolite, e.g. by comparing the peak area of the zeolite particles of the present invention obtained from a diffraction experiment using a Cu radiation X-ray source to the peak area of the same quantity of the standard/reference zeolite particles using the same X-ray source and collection method. Specifically, the crystallinity can be measured in line with the steps described in ASTM method D5357-19 but wherein the steps are adapted for use with the particular type of zeolite. It would be understood that some routine modifications would be needed when analysing different zeolites, for example, the peak positions of the most intense peaks will be different for different zeolites. In the case where the zeolite is zeolite 4A, the crystallinity can be measured following the steps described in ASTM method D5357-19 using NIST standard 8851.

Preferably, the crystallinity of the zeolite particles is from 30% to 70%, optionally from 35% to 65%, such as from 40% to 60%.

In embodiments of the third aspect of the invention, the zeolite particles comprising a the C1-C4 carboxylate are obtainable by contacting zeolite particles with a C1-C4 carboxylic acid (e.g. according to the first aspect of the invention), and the crystallinity of the zeolite particles comprising a C1-C4 carboxylate expressed as a percentage relative to the crystallinity of the zeolite particles prior to being contacted with the acid is 70% or less.

More details on how the crystallinity is calculated is provided in the methods section below. As mentioned above, the reduced crystallinity appears to be an inherent result of process of the first aspect of the invention.

In embodiments of the third aspect of the invention, the zeolite particles have an acidity such that 1 g of the zeolite particles on a dry mass basis dispersed in 99 g of deionised water at 20° C. and atmospheric pressure exhibits a pH of from 5.5 to 7.5, such as from 6 to 7.5 or from 6 to 7. The pH may in embodiments be 8 or below, such as 7.8 or below, 7.6 or below, 7.5 or below, 7.4 or below, or 7.2 or below. The pH may be 7 or below, e.g. less than 7. Such particles have been found to exhibit especially good tanning leather properties.

In embodiments of the third aspect of the invention, the zeolite particles comprising a C1-C4 carboxylate may contain the C1-C4 carboxylate in an amount from 10 wt % to 20 wt % relative to the total weight of the zeolite particles comprising the C1-C4 carboxylate.

In embodiments, the C1-C4 carboxylate is a monocarboxylate. The monocarboxylate may be selected from the group consisting of formate, acetate, propionate, glycolate and lactate, or a mixture of two or more thereof. The C1-C4 carboxylate may be a C1-C2 carboxylate. The monocarboxylate may for example be formate or acetate. In particularly preferred embodiments, the C1-C4 carboxylate is formate. As described in relation to the first aspect of the invention, zeolite particles comprising a short chain carboxylate, and in particular formate, have been shown to be particularly beneficial as a tanning agent.

The zeolite particles of the third aspect may comprise type A, type X or type P zeolite. The zeolite particles may comprise type A or type P. The zeolite particles may consist of such zeolite types as recited above. The zeolite particles may have a Si to Al molar ratio from 0.7 to 2.5. In preferred embodiments, the zeolite particles comprise zeolite 4A, e.g. may consist of zeolite 4A particles. As described in relation to the first aspect of the invention, zeolite 4A particles comprising a C1-C4 carboxylate have been shown to be particularly beneficial as a tanning agent.

In a particularly advantageous embodiment of the third aspect of the invention the C1-C4 carboxylate is formate and the zeolite particles comprise zeolite 4A.

In another particularly advantageous embodiment of the third aspect of the invention the C1-C4 carboxylate is formate, the zeolite particles comprise zeolite 4A, and the zeolite particles have a solids content of at least 70%.

In another particularly advantageous embodiment of the third aspect of the invention the C1-C4 carboxylate is formate, the zeolite particles comprise zeolite 4A, and the zeolite particles have a crystallinity of 70% or less when measured against 100% crystalline zeolite 4A, for example using the method described in ASTM D5357-19.

It will be appreciated that the zeolite particles are typically present as a powder. In embodiments, the particles are a free flowing powder.

### BRIEF DESCRIPTION OF FIGURES

FIG. 1 is a graph of showing the fraction of zeolite particles comprising formate that have a diameter greater than 50 microns as a function of the amount of formic acid dosed to the starting zeolite particles (i.e. zeolite particles prior to acidification). The amount of formic acid is expressed as a percentage relative to the solids content of the starting zeolite particles on a dry mass basis. Data is shown for both the known spray-on route and the presently described slurry route.

FIG. 2 is a graph of showing the fraction of zeolite particles comprising formate with a diameter greater than 50 microns as a function of the final solids content of the zeolite particles for both the known spray-on route and the presently described slurry route.

FIG. 3 is a graph of showing the relationship between the zeolite particle crystallinity and the amount of formic acid dosed to the zeolite particles for both the known spray-on route and the presently described slurry route.

FIG. 4 shows a) an SEM image of zeolite particles that have been treated with formic acid following the comparative spray-on route and b) an SEM image of zeolite particles comprising a C1-C4 carboxylate according to the present invention, i.e. obtained following treatment with formic acid using the presently described slurry route.

### GENERAL METHODS

### Determining Particle Fraction Below 50 Micron in Size

A general method for determining the fraction of zeolite particles with a particle diameter below 50 microns is provided below.

10 g of Zeolite particles are placed in air sieve (e.g. Hosokawa Alpine 200LS) with a mesh size of 50 micron. The air sieve is set to provide a pressure drop over the system of 2500 Pa and activated for a period of 5 min. This pressure drop provides a measure of the air flow through the sieve. The fraction of zeolite particles is calculated based on the weight percentage of particles that were able to pass through the mesh.

### Determining Crystallinity %

A general method for determining the crystallinity of the zeolite particles comprising a C1-C4 carboxylate according to the present invention is provided below. Throughout the examples section, zeolite particles prior to treatment with acid were used as the reference for the crystallinity. These materials were all highly crystalline and considered to be 100% crystalline.

Zeolite particles comprising a C1-C4 carboxylate are used to fill a sample holder of the X-ray diffraction instrument. An X-ray diffraction measurement is performed and the peak area of the refraction peaks determined. For zeolite 4A, the peak area of the peaks at 2θ=16.1°, 21.7°, 24.0°, 27.1°, 29.9° and 34° were then summed. For other zeolites, suitable refraction peaks were chosen and summed. The same procedure is conducted for the reference zeolite particles, i.e. zeolite particles prior to acidification. The summed peak area from the X-ray data of the zeolite particles comprising the C1-C4 carboxylate are then divided by the summed peak area from the X-ray data of the reference zeolite particles in order to express the crystallinity as a percentage.

Typical measurement parameters for the X-ray diffraction data are provided below:
Machine: PANalytical CubiX3.
Detector: PW3011 detector
X-ray generator: Empyrean Cu LFF
Step size reflection angle Δ(2θ=0.02°)
Measuring time per angle: 0.4 sec
Measurement range: from 2θ=5 to 2θ=35°

### Determining Solid Content

The solids content of either the zeolite starting material or the zeolite particle comprising the C1-C4 carboxylate (i.e. the acidified zeolite particles) can be determined by measuring the weight loss after drying for 1 hour at a temperature of 800° C. (e.g. using a Carbolite Gero oven model CWF1200). This method is the standard method used to measure the solids content of zeolite 4A.

### Lab Scale Slurry Reaction (Zeolite 4A and Formic Acid)

Throughout the following methods and examples, the particles will be referred to based on the amount of C1-C4 carboxylic acid dosed to the zeolite particles in the method. While various wording may be used, in all cases, the wt % of carboxylic acid provided refers to the percentage relative to the solids content of the zeolite particles on a dry mass basis prior to addition of carboxylic acid.

A zeolite slurry with a 47% solids content was taken from an operational zeolite plant. The slurry was then diluted by adding water to provide slurries of either 40% or 25% solids content. An amount of 770 g of the diluted slurry was then used in each subsequent trial. As an example, a 770 g slurry with a 40% solids content contains 308 g of zeolite solids by dry mass. The slurry was then mixed with a set amount of formic acid in a beaker using a high-shear mixer (an IKA Eurostar 20-mixer). The weight of formic acid (purity of 98-100%) was calculated based on the target incorporation within the zeolite particles, and varied between 14.6 to 22.9 wt % (relative to the solids content of the zeolite slurry used). For example, an addition of 14.6% formic acid involved adding 45.0 g of formic acid to 770 g of a 40 wt % slurry (14.6% of 308 g=45 g), similarly an addition of 22.9 wt % formic acid involved adding 70.5 g of formic acid to a 40 wt % slurry (22.9% of 308 g=70.5 g). The resulting slurry mixture was then dried into a powder using a lab scale spray dryer, for example a Buchi Mini Spray Dryer B-290. Different final solids contents were achieved by varying the air outlet temperature of the spray dryer.

### Lab Scale Slurry Reaction (Zeolite 4A and Acetic Acid)

770 g of 25 wt % zeolite slurry was prepared as described above. The slurry was then mixed with 46.2 g of acetic acid in a beaker using a high-shear mixer (e.g. an IKA Eurostar 20-mixer). The amount of acetic acid was calculated based on the target incorporation within the zeolite particles of 24 wt % relative to the zeolite dry solids, the same molar amount as 18.4 wt % formic acid. The resulting slurry mixture was then dried into a powder using the lab scale spray dryer (Büchi Mini Spray Dryer B-290).

### Lab Scale Slurry Reaction (Zeolites A24 and Formic Acid)

A 40 wt % zeolite A24 slurry was prepared by mixing 350 g zeolite A24 powder (solid content 90.1%, average particle diameter 1.589 micron) with 438.4 g of water. The resulting 788.4 g of slurry was then mixed with 58.0 g of formic acid in a beaker using a high-shear mixer (e.g. an IKA Eurostar 20-mixer). The amount of formic acid was calculated based on a target incorporation of 18.4 wt % relative to the zeolite dry solids. The resulting slurry mixture was then dried into a powder using a lab scale spray dryer (Büchi Mini Spray Dryer B-290).

### Lab Scale Spray-on Reaction

Zeolite powder was used as the starting material. The zeolite powder was dried to produce powders with differing solids contents. Solids contents of 66, 78, 86 and 94% were used. Zeolites with solids contents of 78 and 86% were taken from an operational zeolite plant during regular production of standard (78% solids) and overdried (86% solids) zeolite 4A. To achieve 94% solids content zeolite 4A, some of the 86% solids zeolite was put in an oven at 250° C. and dried further. To obtain 66% solids content zeolite 4A, some of the 78% solids content zeolite 4A was placed in the bowl of the lab scale mixer (Hobart model A120) and sprayed with water using the handheld plant spray. The powdered zeolite of the desired solid content was then put in the bowl of a lab scale mixer (e.g. Hobart model A120) and formic acid or acetic acid was sprayed on using a handheld plant spray to achieve atomisation. The amount of formic acid was calculated based on the target incorporation within the zeolite particles, and varied between 14.6-22.5 wt % relative to the solids content of the zeolite particles on a dry mass basis, in analogy to the slurry method above. The amount of acetic acid was calculated based on the target incorporation within the zeolite particles of 24.1 wt %.

### Larger Scale Slurry Reaction

In production of zeolites, the zeolite is typically produced by a crystallisation process and is subsequently present as a slurry. It will be appreciated that the slurry of the first aspect of the invention may be the slurry as produced by this crystallisation process. C1-C4 carboxylic acid would then be applied and mixed into the slurry. The slurry would then be transported to a large scale dryer in which hot air is used to evaporate the surplus water and produce the powder.

### EXAMPLES

The aspects of the present invention will now be further described by various non-limiting examples and with reference to the enclosed figures.

### Comparative Examples 1-6 (Spray-on Process—Zeolite 4A+Formic Acid)

Comparative examples using the known spray-on process were prepared as described in the general methods section (see lab scale spray-on reaction). The zeolite used was Zeolite 4A. Formic acid was dosed in amounts of 14.6 wt %, 18.4 wt % and 22.9 wt % relative to the solids content of the zeolite particles prior to acidification. The solid contents of the starting zeolite was varied from 65.8 wt % to 94.2 wt % by re-wetting or pre-drying, with 78.48 wt % being representative of a typically manufactured zeolite, greater values representing “overdried” zeolite.

The fraction of particles with a particle diameter above 50 μm, the final solids content of the zeolite particles after the reaction and the crystallinity were measured as described in the general method section. The results are shown in Table 1.

TABLE 1
Comparative examples produced using the spray-on route

| | Starting | | % wt | Final | | |
|---|---|---|---|---|---|---|
| | Zeolite | Formic | particles | Compound | | |
| | Solids | acid | >50 μm | - Solids | pH (1% | |
| Example | Content | dosed | (Alpine | content | dispersion | Crystallinity |
| No | [wt %] | [wt %] | air sieve) | [wt %] | at 20° C.) | % |
| Typically dried Zeolite | | | | | | |
| 1 | 78.48 | 14.6 | 17.3 | 71.41 | 6.3 | 90 |
| 2 | 78.48 | 18.4 | 21.4 | 71.29 | 6.2 | 88 |
| 3 | 78.48 | 22.9 | 27.3 | 68.18 | 6.0 | 80 |
| Underdried (re-wetted) Zeolite | | | | | | |
| 4 | 65.8 | 18.4 | 71.1 | 59.95 | 6.1 | 56 |
| Overdried zeolite | | | | | | |
| 5 | 86.02 | 14.6 | 11.1 | 77.00 | 6.3 | 100 |
| 6 | 86.02 | 18.5 | 11.3 | 74.57 | 6.2 | 99 |
| 7 | 86.02 | 22.9 | 15.5 | 73.28 | 6.0 | 92 |
| 8 | 94.2 | 18.4 | 11.9 | 80.70 | 6.0 | 87 |

It is evident from examples 1-8 that the spray-on method results in zeolite particles with a high proportion of large particles. For example, in all cases more than 10% of the particles have a particle diameter greater than 50 μm. Some variation is observed in the particle diameter through changes in the levels of formic acid (examples 1-3), or by the changing the solids content of the starting zeolite (examples 4-8). Re-wetting the zeolite (example 4) results a very high fraction of the zeolite particles having a particle diameter above 50 μm, while overdrying the zeolite prior to spraying the formic acid (examples 5-8) shows a reduced fraction of larger particles.

It is also evident that the spray-on method results in zeolite particles with a relativity high crystallinity. In all examples measured, except the re-wetted zeolite, the crystallinity was greater than 70%. Some variation was observed in the crystallinity through changes in the levels of formic acid (examples 1-3).

### Examples 9-15—Slurry Route (Zeolite 4A+Formic Acid)

Examples 9-13 were prepared using the slurry route as described in the general methods section. The zeolite used was Zeolite 4A. The C1-C4 carboxylic acid was formic acid. Analogous to the spray-on route, the formic acid was dosed in amounts of 14.6 wt %, 18.4 wt % and 22.9 wt % relative to the solids content of the zeolite particles in the slurry on a dry mass basis. The solid content of the zeolite slurry was either 25 wt % or 40 wt %.

Examples 14 & 15 were prepared in an analogous manner to examples 9-13 but the drying conditions were altered to change the solids content in the final compound. To obtain the final solids content of 74.8% in experiment 14, the air outlet temperature of the Büchi spray dryer was reduced from 129° C. to 100° C. To obtain the 72.9% solids content in experiment 15, the temperature was reduced to 80° C.

The fraction of particles with a particle diameter above 50 μm, the final solids content of the zeolite particles after the reaction and the crystallinity were measured as described in the general method section. The results are shown in Table 2.

TABLE 2
Examples produced using slurry route

| | | | wt % | Final | | |
|---|---|---|---|---|---|---|
| | Slurry | Formic | particles | Compound | | |
| | Solids | acid | >50 μm | - Solids | pH (1% | |
| Example | Content | dosed | (Alpine | content | dispersion | Crystallinity |
| No | [%] | [wt %] | air sieve) | [wt %] | at 20° C.) | % |
| 9 | 40 | 14.6 | 0.2 | 78.19 | 7.1 | 65 |
| 10 | 40 | 18.4 | 0.9 | 76.68 | 6.7 | 52 |
| 11 | 40 | 22.9 | 4.3 | 74.07 | 6.4 | 40 |
| 12 | 25 | 18.4 | 0.1 | 76.70 | 7.1 | 50 |
| 13 | 25 | 22.9 | 0.1 | 75.35 | 6.8 | 36 |
| 14 | 40 | 18.4 | 3.0 | 74.80 | 6.5 | 52 |
| 15 | 40 | 18.4 | 6.1 | 72.92 | 6.4 | 52 |

In contrast to comparative examples 1-8, examples 9-15 shows that the slurry method results in a reduced number of larger particles. For example, all the examples show zeolite particles comprising a carboxylate where less than 10% of the particles have a particle diameter greater than 50 μm (as determined using the air sieve), and in some cases significantly less than 10%. Modest variation in the percentage of zeolite particles having a diameter greater than 50 μm is observed through changes in the levels of formic acid (examples 9-11), or by the changing the solids content of the slurry (compare examples 10 & 12). Examples 14 & 15 also show that the solids content of the final zeolite particles can be varied while still achieving a high fraction of smaller particles.

It is also evident that the slurry method results in zeolite particles with a relativity low crystallinity. In all examples measured, the crystallinity was less than 50%. Some variation is observed in the crystallinity through changes in the levels of formic acid (examples 9-11), or by the changing the solids content of the starting slurry (examples 12).

### Alternative Carboxylic Acid (Zeolite 4A+Acetic Acid)

Comparative example 16 was prepared via the known spray-on process (as described above) using acetic acid. The acetic acid was applied at a concentration of 24.1 wt % compared to the final compound to give a comparable molar amount to the 18.4 wt % formic acid examples. The solid contents of the starting zeolite was 78.48 wt %

Example 17 were prepared using the slurry route as described in the general methods section. The zeolite used was Zeolite 4A. The C1-C4 carboxylic acid was acetic acid. The acetic acid was dosed in an amount of 24 wt % compared to the final compound. The solid content of the zeolite slurry was 25 wt %.

The fraction of particles with a particle diameter above 50 μm, the final solids content of the zeolite particles after the reaction and the crystallinity were measured as described in the general method section. The results are shown in Table 3.

TABLE 3
Examples using acetic acid

| | | | wt % | Final | | |
|---|---|---|---|---|---|---|
| | | Acetic | particles | Compound | | |
| | Solids | Acid | >50 μm | - Solids | | |
| | Content | dosed | (Alpine | content | pH (1% DS | Crystallinity |
| Example No | [wt %] | [wt %] | air sieve) | [wt %] | at 20° C.) | % |
| 16 | 78.48 | 24.1 | 1.5 | 67.30 | 6.1 | 79 |
| (Comparative) | (powder) | | | | | |
| 17 | 25 | 24.0 | 0.2 | 75.50 | 7.0 | 77 |
| (Slurry route) | (slurry) | | | | | |

Analogous to the results for formic acid, the slurry method (example 17) results in a significantly reduced fraction of zeolite particles having a particle diameter greater than 50 μm than using the known spray-on method (comparative example 16).

### Alternative Zeolite (Zeolite A24+Formic Acid)

Comparative example 18 was prepared via the known spray-on process (as described above) using Zeolite A24 (tradename Doucil® A24). Doucil® A24 is a P-type zeolite (cf. Zeolite 4A which is an A-type zeolite). Formic acid was applied at a concentration of 18.4 wt % compared to the final compound. The solid contents of the starting zeolite was 90.11 wt %

Example 19 were prepared using the slurry route as described in the general methods section. The zeolite used was Zeolite A24. The C1-C4 carboxylic acid was formic acid. The formic acid was dosed in an amount of 18.4 wt % compared to the zeolite dry solids. The solid content of the zeolite slurry was 40 wt %.

The fraction of particles with a particle diameter above 50 μm, the final solids content of the zeolite particles after the reaction and the crystallinity were measured as described in the general method section. The results are shown in Table 4.

TABLE 4
Examples using Zeolite A24

| | | | wt % | Final | | |
|---|---|---|---|---|---|---|
| | | Formic | particles | Compound | | |
| | Solids | Acid | >50 μm | - Solids | | |
| | Content | dosed | (Alpine | content | pH (1% DS | Crystallinity |
| Example No | [%] | [wt %] | air sieve) | [wt %] | at 20° C.) | % |
| 18 | 90.11 | 18.4 | 50.9 | 77.47 | 5.6 | 83 |
| (Comparative) | (powder) | | | | | |
| 19 | 40 | 18.4 | 5.4 | 79.93 | 6.1 | 39 |
| (Slurry route) | (slurry) | | | | | |

Analogous to the results for Zeolite 4A, the slurry method (example 19) results in significantly reduced fraction of zeolite particles have a particle diameter greater than 50 μm compared to the known spray-on method (comparative example 18).

### DESCRIPTION OF FIGURES

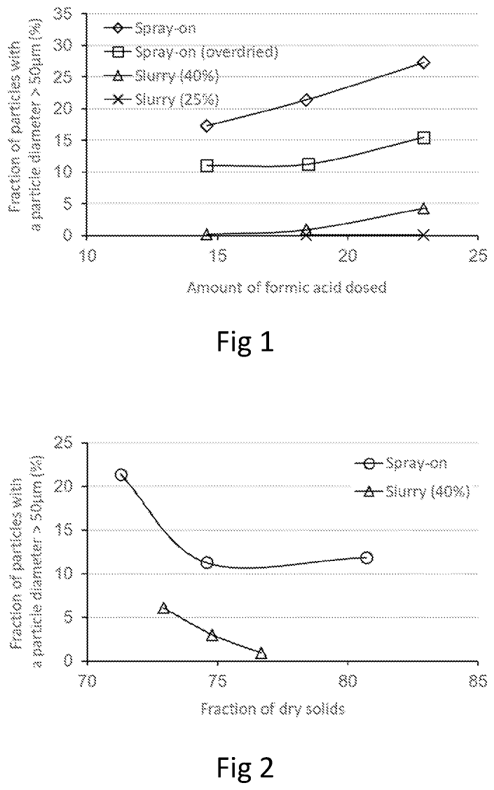

Selected data from table 1 and 2 above are presented in FIGS. 1, 2 and 3.

FIG. 1 is a graph plotting the fraction of zeolite particles comprising formate that have a particle diameter greater than 50 μm against the concentration of formic acid used in the acidification reaction. The graph shows data for comparative particles obtained via a comparative spray-on route with a typically dried zeolite starting material (examples 1-3) and an overdried Zeolite starting material (examples 5-8), as well as data for particles prepared by the inventive slurry route described herein, varying the concentration of zeolite solids in the starting slurry from 40 wt % (examples 9-11) to 25 wt % (examples 12 & 13).

As discussed above, the slurry route (triangles and crosses) leads to a lower fraction of zeolite particles that have a particles diameter above 50 μm compared to the spray-on route (diamonds and squares). This is consistent for all levels of formic acid used. Using an overdried zeolite starting material for the spray-on route (squares) provides benefits over the typically dried zeolite starting material (diamonds), but the fraction of zeolite particles with a particle diameter above 50 μm remains comparatively higher than obtained using the inventive slurry route according to the invention. Using a 25 wt % slurry can be seen to be particularly beneficial; resulting in a very low fraction of particles larger than 50 μm.

FIG. 2 is a graph plotting the fraction of zeolite particles that have a particle diameter greater than 50 μm against the fraction of dry solids in the final compound. Data is shown for the spray-on route (circles) and the slurry route with slurry solids content of 40 wt % (triangles). The percentage of formic acid administered was 18.4 wt % in all cases. The data points correspond to comparative examples 2, 4, and 8 and examples 10, 14 and 15. The data show that the diameters of the zeolite particles comprising formate remain comparatively low for the slurry process of the invention despite some variation in final solids content.

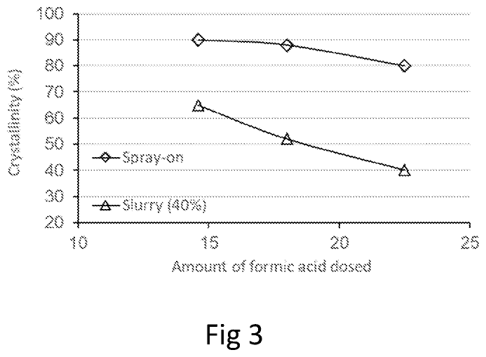

FIG. 3 is a graph plotting the crystallinity of zeolite particles comprising formate against the concentration of formic acid used in the acidification reaction. The graph shows data for comparative particles obtained via a comparative spray-on route with a typically dried zeolite starting material (examples 1-3), and data for particles prepared by the inventive slurry route described herein, using a concentration of zeolite solids in the starting slurry of 40 wt % (examples 9-11).

As discussed above, the slurry route (triangles) leads to zeolite particles that have a low crystallinity, while the spray-on route (diamonds) typically leads to higher crystallinity values. It is of note that using a re-wetted zeolite starting material for the spray-on route (not shown but seen in example 4) also provides a lower crystallinity, however, this example is particularly unsuited to tanning applications due to the high percentage of larger particles.

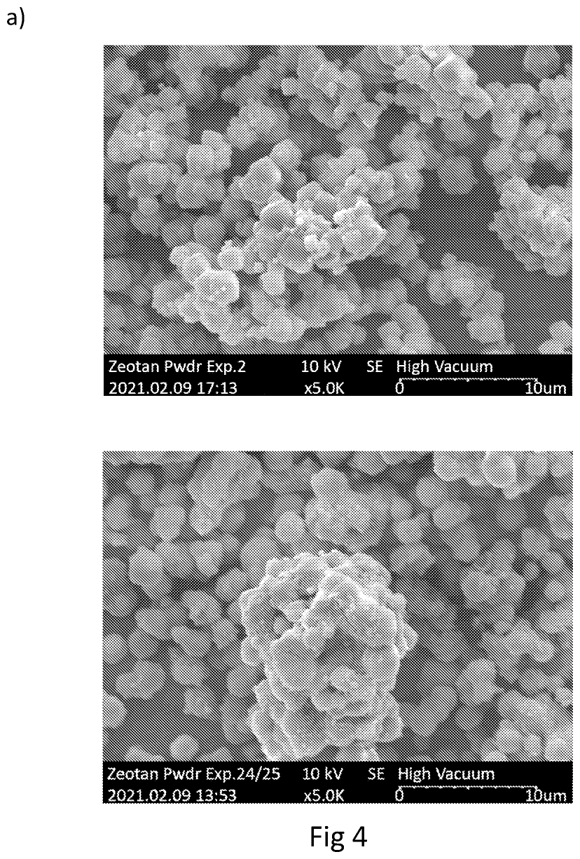

FIG. 4 shows SEM images for comparative particles obtained via the spray-on route with an overdried zeolite starting material (example 6), and data for particles prepared by the inventive slurry route described herein using a concentration of zeolite solids in the starting slurry of 40 wt % (example 10). The spray-on route with an overdried zeolite starting material produces a highly crystalline material, which can be seen by the well-defined particle shapes. The particles prepared by the inventive slurry route meanwhile have less well-defined shapes, supporting the lower crystallinity observed.

Although the present invention has been described in detail, it should be understood that various changes, substitutions, and alterations are contemplated without departing from the principle and scope of the invention. Accordingly, the scope of the present invention defined herein and particularly the following claims should be interpreted in consideration of the appropriate equivalents. The terms “a”, “an” and “the” do not preclude the presence of multiple referents, unless the context clearly dictates otherwise. Optional or optionally means that the feature or activity may or may not be present. Either is contemplated. In embodiments, the optional feature or features may be present. Alternatively, the optional feature or features may not be present. Ranges may be expressed herein as “from” one particular value, and/or “to” another particular value, which is intended to be inclusive of the end-points of the range.

We claim:

1. A method of manufacturing zeolite particles comprising a C1-C4 carboxylate suitable for use in leather tanning, the method comprising the steps of:
(i) contacting a zeolite particle slurry with a C1-C4 carboxylic acid to increase the acidity of the zeolite particles; and
(ii) removing liquid from the slurry to obtain the zeolite particles comprising the C1-C4 carboxylate.

2. The method of claim 1, wherein the wt % of zeolite particles in the slurry on a dry mass basis is from 10 wt % to 55 wt % relative to the total weight of the slurry.

3. The method of claim 1, wherein the step of removing liquid from the slurry is performed such that the zeolite particles comprising the C1-C4 carboxylate have a solids content of at least 70%.

4. The method of claim 1, wherein the zeolite particles comprising the C1-C4 carboxylate have an acidity such that 1 g of the zeolite particles on a dry mass basis dispersed in 99 g of water at 20° C. and atmospheric pressure exhibits a pH of from 5 to 8.

5. The method of claim 1, wherein the C1-C4 carboxylic acid is selected from the group consisting of formic acid, acetic acid, propionic acid, glycolic acid and lactic acid, or is a mixture of two or more thereof.

6. The method of claim 1, wherein the zeolite particles in the zeolite particle slurry comprise type A, type P or type X zeolite.

7. The method claim 1, wherein prior to the step of contacting the zeolite particle slurry with the C1-C4 carboxylic acid, the method comprises the step of preparing the zeolite slurry, wherein preparing the zeolite slurry comprises crystallizing zeolite particles from water, to produce the zeolite particle slurry.

8. The method of claim 1, wherein the C1-C4 carboxylic acid is added in an amount from 5 wt % to 30 wt % relative to the solids content of the zeolite particles in the slurry on a dry mass basis.

9. Zeolite particles comprising a C1-C4 carboxylate suitable for use in leather tanning obtained or obtainable by the method of claim 1.

10. (canceled)

11. (canceled)

12. (canceled)

13. Zeolite particles suitable for use in leather tanning, wherein the zeolite particles have an acidity such that 1 g of the zeolite particles on a dry mass basis dispersed in 99 g of deionised water at 20° C. and atmospheric pressure exhibits a pH of from 5 to 8, wherein the zeolite particles comprise a C1-C4 carboxylate, and wherein at least 90% by weight of the zeolite particles have a particle diameter of 50 μm or less.

14. The zeolite particles of claim 13, wherein the zeolite particles have a solids content of at least 70 wt %.

15. The zeolite particles of claim 13, wherein the zeolite particles have a crystallinity of 70% or less when measured against 100% crystalline zeolite particles of the same type of zeolite.

16. The zeolite particles according to claim 13, wherein at least 95% of the zeolite particles have a particle diameter of 50 μm or less.

17. The zeolite particles according to claim 13, wherein the C1-C4 carboxylate is a monocarboxylate selected from the group consisting of formate, acetate, propionate, glycolate and lactate, or a mixture of two or more thereof.

18. (canceled)

19. (canceled)

20. The zeolite particles according to claim 13, wherein the zeolite particles comprise type A, type X or type P zeolite.

21. The zeolite particles of according to claim 13, wherein the zeolite particles have a Si to Al molar ratio from 0.7 to 2.5.

22. (canceled)

23. A tanning composition comprising the zeolite particles according to claim 13, in combination with one or more excipients.

24. A method of manufacturing a tanning composition comprising:
(i) manufacturing zeolite particles comprising a C1-C4 carboxylate by the method according to claim 1; and
(ii) combining the zeolite particles comprising the C1-C4 carboxylate with one or more excipients to provide the tanning composition.

25. (canceled)

26. Use of the zeolite particles as defined in claim 13 in producing a tanning composition for use in tanning animal hide.

27. Use of the zeolite particles comprising the C1-C4 carboxylate according to claim 13 in a method of tanning an animal hide.
